(19) United States
(12) Patent Application Publication
(10) Pub. No.: US 2020/0073593 A1
(43) Pub. Date: Mar. 5, 2020

(54) MEMORY CONTROLLER AND ASSOCIATED ACCESSING METHOD AND ELECTRONIC DEVICE

(71) Applicant: RayMX Microelectronics, Corp., Anhui province (CN)

(72) Inventors: Yen-Chung CHEN, Zhubei City (TW); Han-Ting TSAI, Taipei City (TW); Sek-Wang LAM, Hsinchu City (TW); Tzu-Yu CHAO, Taichung City (TW)

(21) Appl. No.: 16/423,356

(22) Filed: May 28, 2019

(30) Foreign Application Priority Data
Aug. 30, 2018 (TW) 107130356

(51) Int. Cl. G06F 3/06; G06N 3/04; G06N 3/08

(52) U.S. Cl. CPC G06F 3/0659; G06F 3/0611; G06N 3/08; G06N 3/04; G06F 3/0673

(57) ABSTRACT

The present invention provides a memory controller including an artificial intelligence (AI) module and a microprocessor. In the operations of the memory controller, the AI module receives a read command from a host device, and generates an auxiliary read command according to the read command. The microprocessor reads first data from a memory module according to the read command, and reads second data from the memory module according to the auxiliary read command, wherein a logical address the second data is not recorded in the read command.

### BACKGROUND OF THE INVENTION

### 1. Field of the Invention

The present invention relates to a memory controller.

### 2. Description of the Prior Art

In a conventional memory controller (e.g., flash memory controller), the operations are executed faithfully based on access commands from the host device. For example, the memory controller reads data from a memory module only when receiving a read command from a host device, and the memory controller further sends the data read from the memory module to the host device. However, because an access speed of the memory module is slow, and the memory controller starts reading the data from the memory module only when receiving the read command, the reading speed of the memory cannot be further improved, and the performance of the system is worsened.

### SUMMARY OF THE INVENTION

It is therefore one of objectives of the present invention to provide a memory controller, which can predict data required by the host device in the future according to the current read command, and read the data from the memory module in advance and store the data into a static random access memory (SRAM) or a dynamic random access memory (DRAM) having higher accessing speed. Therefore, if the memory controller receives the related read command later, the memory controller can immediately send the data to the host device, to improve the system efficiency.

In a first embodiment of the present invention, a memory controller comprises an artificial intelligence (AI) module, for receiving a read command from a host device, and generating an auxiliary read command according to the read command and at least one decision logic; and a microprocessor, coupled to the AI module, for reading first data from a memory module according to the read command, and reading second data from the memory module according to the auxiliary read command, wherein a logical address corresponding to the second data is not recorded in the read command.

In a second embodiment of the present invention, a method for accessing a memory module is disclosed, wherein the method comprises the steps of: receiving a read command from a host device; generating an auxiliary read command according to the read command and at least one decision logic; reading first data from the memory module according to the read command; transmitting the first data to the host device; reading second data from the memory module according to the auxiliary read command, wherein a logical address corresponding to the second data is not recorded in the read command; and storing the second data into a memory without immediately transmitting the second data to the host device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to one embodiment of the present invention.

FIG. 2 is a flowchart of a method for accessing a memory module according to one embodiment of the present invention.

### DETAILED DESCRIPTION

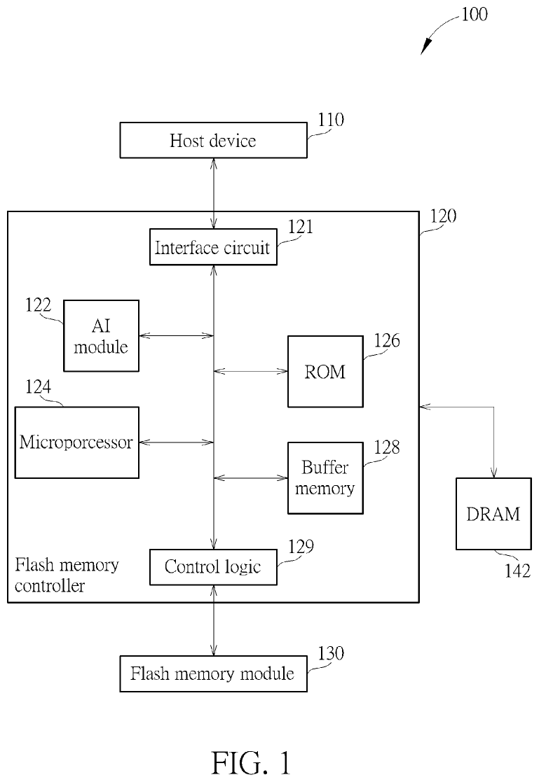

FIG. 1 is a diagram illustrating an electronic device 100 according to one embodiment of the present invention. As shown in FIG. 1, the electronic device 100 comprises a host device 110, a memory controller 120, a memory module 130 and a DRAM 142, where the memory controller 120 comprises an interface circuit 121, an AI module 122, a microprocessor 124, a buffer memory 126 (e.g. SRAM), a read only memory (ROM) 128 and a control logic 129. The ROM 128 is used to store program codes, and the microprocessor 124 is configured to executed the program codes to control the access of the memory module 130, and the elements within the memory controller 120 may communicate with each other via a bus shown in FIG. 1. In this embodiment, the memory controller 120 and the memory module 130 can be regarded as a solid-state drive (SSD), the electronic device 100 can be any computer or server having the SSD, and the host device 110 can be a processor configured to access the memory module 130 via the memory controller 120. The interface circuit 121 can be a Peripheral Component Interconnect Express (PCI-e) interface or an Advanced Technology Attachment (ATA) interface or Universal Serial Bus (USB) interface. The AI module 122 can also be called a Machine Learning module.

The memory module 130 comprises at least one memory chip, each memory chip comprises a plurality blocks, each block comprises a plurality of pages. In the designs of the memory, each block is a minimum erasing unit, that is all the data within the block must be erased together, and only deleting a portion of the data of the block is not allowed. In addition, each page is a minimum writing unit.

In an embodiment, the AI module 122 has an independent circuit architecture that can continuously generate and update a plurality of decision logics for subsequent use by continuously receiving successive read commands and performing analysis. In this embodiment, the decision logics of the AI module 122 are used to determine or predict the order relationship between the read commands from the host device 110, to determine/predict a next read command following a current read command received from the host device 100, in order to perform some operations in the memory controller 120 in advance. Specifically, the AI module 122 continuously receives the read commands from the host device 110 when the electronic device 100 is operating, and generates the decision logics that can be used to determine the order relationships of the read commands through recording and training. For example, if the AI module 122 receives the read command asking for the data with the logical address LBA_5 and immediately receives the next read command asking for the data with the logical address LBA_100 many times, the AI module 122 can learn and determine that the host device 110 has a high probability to send the successive read commands for the data having the logical addresses LBA_5 and LBA_100, and the AI module 122 can build the decision logics indicating that the logical address LBA_100 is immediately after the logical address LBA_5. Therefore, when the AI module 122 receives the read command having the logical address LBA_5 from the host device 110, the AI module 122 can determine that it is very likely that the host device 110 may immediately send the read command having the logical address LBA_100, so the AI module 122 can notify the microprocessor 124 to perform some preprocesses. It is noted that the aforementioned logical addresses LBA_5 or LBA_100 may represent single data (e.g. 4 kilobytes) or a logical address range corresponding to a plurality of data.

In one embodiment, the AI module 122 employs a Deep Learning algorithm. In one embodiment, the AI module 122 utilizes an artificial neural network (ANN) architecture to predict the next read command based on the current read command. In this embodiment, the decision logics are weighting values of the nodes in artificial neural network (ANN) architecture. In a preferred embodiment, the ANN architecture can be a Deep Convolutional Network (DCN) architecture or a Neural Turing Machine (NTM) architecture. In another embodiment, the AI module 122 includes an AI circuit and a memory unit (not shown in FIG. 1) for storing a predetermined AI algorithm and the AI circuit loads the predetermined AI algorithm to perform deep learning on the plurality of read commands. In an embodiment, the memory controller 120 can be implemented by an application-specific integrated circuit (ASIC).

Because the AI module 122 is trained by the read commands sent by the host device 110 in the actual operations to generate the plurality of decision logics, the AI module 122 can accurately determine the logical address relationships of the data that the host device 110 sequentially requests, especially these logical addresses may not be continuous logical addresses. That is, the aforementioned logical addresses LBA_5 and LBA_100 are two discontinuous logical addresses or incomplete continuous logical addresses or incomplete continuous logical address ranges.

In one embodiment of the present invention, due to considerations of the ability and the efficiency of the AI module 122, the AI module 122 can be designed to receive a plurality of specific read commands from the host device 110 to generate the decision logics only at a specific period that the electronic device 100 executes at least one specific operation. For example, because the user is most concerned about the boot time of the electronic device 100 and the startup time of some specific software/applications, the user may set the AI module 122 via an user interface of the electronic device 100 to make the AI module 122 be trained to generate/update the decision logics only when the electronic device 100 is powered on or the electronic device 100 executes some specific software/applications, that is the AI module 122 is not trained to generate/update the decision logics at other times. Specifically, by using the setting of the user, the AI module 122 can always perform the training operations within seven seconds after the electronic device 100 is powered on, to generate/update the decision logics. Because every time the data/files to be read when the electronic device 100 is powered on have a great similarity, by performing the training operations when the electronic device 100 is powered on many times, the AI module 122 can accurately and efficiently complete the training of the decision logics. In addition, because the decision logics of the AI module 122 are not updated after seven seconds of the electronic device 100 being powered on, the decision logics are not interfered by the disordered read commands generated according to the other operations of the electronic device 100. In another example, by using the setting of the user, the AI module 122 can always perform the training operations within four seconds after the electronic device 100 executes a specific application, to generate/update the decision logics, to make the AI module 122 accurately and efficiently complete the training of the decision logics. In addition, because the decision logics of the AI module 122 are not updated after four seconds of the electronic device 100 executing the specific application, the decision logics are not interfered by the disordered read commands generated according to the other operations of the electronic device 100.

In this embodiment, the user can stop the training operations of the AI module 122 via the user interface at any time, that is AI module 122 stop updating the decision logics. For example, assuming that the AI module 122 has updated the decision logics during ten startup procedures of the electronic device 100, the AI module 122 may stop training the decision logics to lower the system loading because the decision logics should be sufficient to reflect the order of the read commands when the electronic device 100 is powered on.

In the operations of the electronic device 100, when the memory controller 120 receives a read command from the host device 110, the AI module 122 will analyze the logical address comprised in the read command (i.e. the logical address corresponding to data requested by the read command), and determine an auxiliary read command according to the internal decision logics, where the logical address comprised in the auxiliary read command is associated with another read command following the read command in the previous training operations of the AI module 122. For example, assuming that the AI module 122 builds the decision logics that the logical address LBA_100 is immediately after the logical address LBA_5 in the previous training operations, if the read command received by the memory controller 120 comprises the logical address LBA_5, the auxiliary read command generated by the AI module 122 will comprise the logical address LBA_100.

Then, the microprocessor 124 refers to the logical address comprised in the read command and a logical address to physical address mapping table stored in the buffer memory 126 to determine a physical address of the memory module 130, and the microprocessor 124 further reads first data according to the physical address, and immediately send the first data to the host device 110. In addition, if the memory controller 120 and the memory module 130 are idle, the microprocessor 124 will refer to the logical address comprised in the auxiliary read command and the logical address to physical address mapping table stored in the buffer memory 126 to determine another physical address of the memory module 130, and the microprocessor 124 further reads second data according to the physical address, and stores the second data into the buffer memory 126 or the DRAM 142. It is noted that, at this time the memory controller 120 does not receive a next read command from the host device 110, and the memory controller 120 does not transmit the second data to the host device 110 currently.

For example, assuming that the read command includes the logical address LBA_5, and the auxiliary read command includes the logical address LBA_100, the memory controller 120 immediately reads the first data with the logical address LBA_5 from the memory module 130, and transmits the first data to the host device 110. Then, the memory controller 120 reads the second data with the logical address LBA_100 from the memory module 130 in advance, and the second data is temporarily stored in the buffer memory 126 or the DRAM 142, and the second data is not immediately transmitted to the host device 110.

Then, if the memory controller 120 receives the other read command including the logical address LBA_100, the memory controller 120 can immediately transmit the second data stored in the buffer memory 126 or the DRAM 142 to the host device 110. Because the access speed of the buffer memory 126 or the DRAM 142 is faster than the access speed of the memory module 130, the method for reading the second data in advance of the embodiment can increase the reading speed, and the efficiency of the electronic device 100 can be improved.

On the other hands, if the memory controller 120 does not receive another read command including the logical address LBA_100 for a period of time, the memory controller 120 can delete the second data from the buffer memory 126 or the DRAM 142 at an appropriate time to release the memory space.

It is noted that quantity of the read commands and the quantity of the logical addresses in the above embodiment are for illustrative purposes only. In other embodiments of the present invention, the decision logics of the AI module 122 can be used to determine the logical address relationships of more than two data requested by the host device 110, and the AI module 122 can predict the logical addresses corresponding to the second read command, the third read command, the fourth read command etc., after receiving the first read command, and the generate a plurality of auxiliary read commands to the microprocessor 124 to read the data in advance and stored the data into the buffer memory 126 or the DRAM 142.

In an embodiment, a format of the auxiliary read command and that of the read command are the same. In other embodiment, the auxiliary read command is just a logical block address (LBA). In other embodiment, the auxiliary read command comprises a logical block address (LBA) and length of required data.

It is noted that quantity of the logical block addresses of the read commands in the above embodiment as a feature for machine learning, but the invention is not limited thereto. In other embodiments of the present invention, the AI module 122 can also utilize a logical block address and at least one of the following features of the access command for machine learning: a length of the access command, a type of the access command, and an interval time of the access command etc. In this embodiment, at least one of the logical block address, the length, the type, and the interval time of the access command is the input of the AI module 122, the decision logic is weighting value of the AI module 122, and the auxiliary read command is the output of the AI module 122.

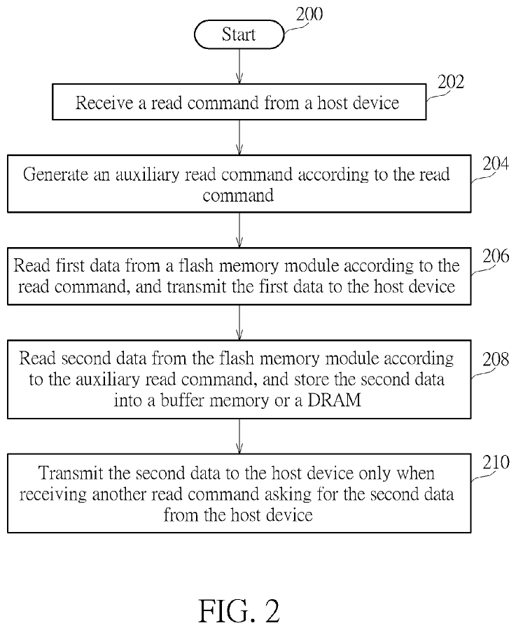

FIG. 2 is a flowchart of a method for accessing the memory module 130 according to one embodiment of the present invention. Refer to FIG. 1 and the related descriptions, the flow is described as follow.

Step 200: the flow starts.

Step 202: receive a read command from a host device 110.

Step 204: generate an auxiliary read command according to the read command.

Step 206: read first data from a memory module 130 according to the read command, and transmit the first data to the host device 110.

Step 208: read second data from the memory module 130 according to the auxiliary read command, and store the second data into a buffer memory 126 or a DRAM 142.

Step 210: transmit the second data to the host device 110 when receiving another read command asking for the second data from the host device 110.

Briefly summarized, in the memory controller 120 of the present invention, the AI module 122 is provided to predict a next read command of the current read command, and read the data corresponding to the predicted next read command in advance and store the data into the buffer or RAM having faster accessing speed, in order to transmit the data to the host device when receiving the associated read command(s) later. In other words, before receiving the next read command of the current read command, the memory controller 120 of the present invention can predict the next read command of the current read command and perform data early access according to the predicted next read command. By using the embodiments of the present invention, the data reading speed becomes faster and the system efficiency is improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A memory controller, comprising:
an artificial intelligence (AI) module, to receive a read command from a host device, and to generate an auxiliary read command according to the read command and at least one decision logic; and
a microprocessor, coupled to the AI module, to read first data from a memory module according to the read command, and to read second data from the memory module according to the auxiliary read command, wherein a logical address corresponding to the second data is not recorded in the read command.

2. The memory controller of claim 1, wherein the logical address corresponding to the second data and a logical address corresponding to the first data are not completely continuous.

3. The memory controller of claim 1, wherein the microprocessor immediately transmits the first data to the host device, and stores the second data into a memory without immediately transmitting the second data to the host device.

4. The memory controller of claim 3, wherein the microprocessor transmits the second data to the host device when the microprocessor receives another read command comprising the logical address corresponding to the second data, and wherein the read command is before the another read command.

5. The memory controller of claim 1, wherein before the memory controller receives the read command from the host device, the AI module receives a plurality of specific read commands associated with the read command many times to generate/update the at least one decision logic.

6. The memory controller of claim 5, wherein the plurality of specific read commands comprise at least one first read command and at least one second read command, the at least one first read command and the read command have the same logical address, and the at least one second read command is after the at least one first read command at the time of receipt.

7. The memory controller of claim 1, wherein the AI module refers to a user's setting to receive the plurality of specific read commands from the host device many times, to generate/update the at least one decision logic.

8. The memory controller of claim 1, wherein the AI module comprises an artificial neural network (ANN) architecture, the at least one decision logic is weighting values of nodes of the ANN architecture.

9. The memory controller of claim 8, wherein the ANN architecture is one of Deep Convolutional Network (DCN) architecture and Neural Turing Machine (NTM) architecture.

10. The memory controller of claim 8, wherein at least two inputs of the ANN architecture are at least two of a logical block address of the access command, length of the access command, a type of the access command, and an interval time of the access command.

11. A method for accessing a memory module, comprising:
receiving a read command from a host device;
generating an auxiliary read command according to the read command and at least one decision logic;
reading first data from the memory module according to the read command;
transmitting the first data to the host device;
reading second data from the memory module according to the auxiliary read command, wherein a logical address corresponding to the second data is not recorded in the read command; and
storing the second data into a memory without immediately transmitting the second data to the host device.

12. The method of claim 11, wherein the logical address corresponding to the second data and a logical address corresponding to the first data are not completely continuous.

13. The method of claim 11, wherein the auxiliary read command comprises a logical address.

14. The method of claim 11, further comprising:
receiving another read command comprising the logical address corresponding to the second data; and
transmitting the second data stored in the memory to the host device according to the another read command;
wherein the step of reading the second data from the memory module before the step of receiving the another read command.

15. The method of claim 11, the method further comprising:
receiving a plurality of specific read commands associated with the read command many times to generate/update the at least one decision logic;
wherein the step of receiving the plurality of specific read commands is before the step of receiving the read command.

16. The method of claim 15, wherein the plurality of specific read commands comprise at least one first read command and at least one second read command, the at least one first read command and the read command have the same logical address, and the at least one second read command is after the at least one first read command at the time of receipt.

17. The method of claim 15, wherein the method is executed by an electronic device, wherein the step of receiving the plurality of specific read commands associated with the read command many times to generate/update the decision logic according to a user's setting, wherein the user's setting is at least one specific period that the electronic device executes a specific operation.

18. The method of claim 11, wherein the at least one decision logic is weighting values of an artificial neural network (ANN) architecture,

19. The method of claim 18, wherein the ANN architecture is one of Deep Convolutional Network (DCN) architecture and Neural Turing Machine (NTM) architecture.

20. The method of claim 18, wherein the at least one decision logic is updated according to at least one of a logical block address of the access command, length of the access command, a type of the access command, and an interval time of the access command.
